(19) United States
(12) Patent Application Publication
(10) Pub. No.: US 2012/0243156 A1
(43) Pub. Date: Sep. 27, 2012

(54) INTEGRATED USB HUB

(75) Inventor: Ching-Wei Cheng, Keelung (TW)

(73) Assignee: ACTION STAR ENTERPRISE CO. LTD., New Taipei City (TW)

(21) Appl. No.: 13/070,630

(22) Filed: Mar. 24, 2011

(51) Int. Cl. G06F 1/16

(52) U.S. Cl. 361/679.02

(57) ABSTRACT

The present invention relates to an integrated USB hub, comprising: a circuit board, a first electrical connector, a main-controlling chip, at least one second electrical connector, at least one third electrical connector, and a plurality of fourth electrical connector, wherein the first electrical connector, the at least one second electrical connector, the at least one third electrical connector, and the plurality of fourth electrical connector are disposed on the circuit board and coupled to the main-controlling chip; Therefore, through the controlling of the main-controlling chip, a user may connect a first electronic device, a second electronic device and a third electronic device to the second electrical connector, the third electrical connector and the fourth electrical connector, respectively, so as to control and operate the first electronic device, the second electronic device and the third electronic device via a host computer and the main-controlling chip.

### BACKGROUND OF THE INVENTION

1. Technical Field

The present invention relates to an USB hub, and more particularly, to an integrated USB hub having at least five USB electrical connectors.

2. Description of Related Art

Recently, personal electronic products and computer peripheral devices are continuously introduced new, for example, digital cameras, smart phones, multimedia players, card readers, scanners, printers, webcam, etc. Moreover, for making the personal electronic product or the computer peripheral device be connected to the computer and facilitating the user to deal with data between the personal electronic product and the computer or between the computer peripheral device and the computer, USB (Universal Serial Bus) electrical connector become an important connecting device used for connecting the personal electronic product and the computer, or connecting the computer peripheral device and the computer.

Moreover, for making the user able to connect at least two personal electronic devices or at least two computer peripheral devices to one computer, computer venders integrated a plurality of USB electrical connectors to an USB hub. Please refer to FIG. 1, which illustrates a framework diagram of a conventional USB hub. As shown in FIG. 1, the conventional USB hub 1′ includes four USB electrical connector receptacles 11′ and one USB electrical connector plug 12′, wherein the USB electrical connector plug 12′ is adopted for connecting to a USB electrical connector receptacle 21′ of a computer 2′. Thus, if the user wants to use a flash drive 3′ and a webcam 4′ at the same time, it merely inserts the flash drive 3′ into one USB electrical connector receptacle 11′ of the USB hub 1′, and inserts an USB electrical connector plug 41′ of the webcam 4′ into another one USB electrical connector receptacle 11′ of the USB hub 1′, such that the flash drive 3′ and the webcam 4′ are electrically connected to the computer 2′ via the USB hub 1′, so as to facilitate the user use the flash drive 3′ and the webcam 4′.

Besides, for further satisfying the demand of high storage capacity and high data throughput of the electronic products, the data transfer format of the USB electrical connector is developed from USB 2.0 to USB 3.0. However, not every electronic products are equipped with USB 3.0 electrical connector, in fact, it still uses USB 2.0 electrical connector as the data transfer interface for some electrical connectors. So that, for making the user connect the electronic device with USB 2.0 electrical connector and electronic device with USB 3.0 electrical connector to the computer at the same time, computer venders propose an improved USB hub.

Please refer to FIG. 2, which illustrates a stereo view of an improved conventional USB hub. As shown in FIG. 2, the improved conventional USB hub 1″ includes: a housing 11″, a circuit board 12″, four first connectors 13″, three second connectors 14″, a third connector 17″, a main-controlling interface, a first connector controlling chip 18″, and a second connector controlling chip 19″, wherein the first connector 13″ is an USB 3.0 electrical connector and coupled to the first connector controlling chip 18″, and the the second connector 14″ is an USB 2.0 electrical connector, coupled to the second connector controlling chip 19″; moreover, the first connector controlling chip 18″ and the second connector controlling chip 19″ are further coupled to the main-controlling interface 16″.

So that, through above description, it can understand the the improved USB hub 1″ able to provide the user with the function for connecting the electronic device with USB 2.0 electrical connector and the electronic device with USB 3.0 electrical connector to the computer. In addition, please refer to FIG. 3, which illustrates a circuit framework diagram of the circuit board of the improved conventional USB hub. In the circuit framework of the improved conventional USB hub 1″, as shown in FIG. 3, when the user connects the electronic device with USB 3.0 electrical connector to the first connector 13″, the main-controlling interdace 16″ executes switching for making electronic device able to electrically connect to the computer via the first connector 13″, the first connector controlling chip 18″, the main-controlling interface 16″, and the third connector 17″; Similarly, when the user connects the electronic device with USB 2.0 electrical connector to the second connector 14″, the main-controlling 16″ executes switching for making the electronic device able to electrically connect to the computer through the second connector 14″, the second connector controlling chip 19″, the main-controlling interface 16″, and the third connector 17″.

However, for the switching way of the internal controlling circuit of the improved USB hub 1″, that is to execute the switching by the main-controlling interface 16″, so as to make the computer 2″ electrically connect to the electronic device which is connected to the second connector 14″, or make the computer 2″ electrically connect to the electronic device which is connected to the first connector 13″. Thus, it can further understand that when the user select using the group of the USB 2.0 electrical connectors (i.e., select using the group of the second connectors 14″), the group of the USB 3.0 electrical connectors can not be used (i.e., the group of the first connectors 13″ can not be used), that causes waste on the use of the electrical connectors; simultaneously, that also causes the usable electrical connector ports for the user.

Accordingly, in view of the conventional USB hub and the improved USB hub still have shortcomings and drawbacks, the inventor of the present application has made great efforts to make inventive research thereon and eventually provided an integrated USB hub.

### BRIEF SUMMARY OF THE INVENTION

The first objective of the present invention is to provide an integrated USB hub, in which, at least one first electrical connector, at least one second electrical connector and a plurality of fourth electrical connectors are simultaneously coupled to a main-controlling chip, thus, a user can connect a first electronic device, a second electronic device and a third electronic device to the first electrical connector, the second electrical connector and the fourth electrical connector, so as to control and operate the first electronic device, the second electronic device and the third electronic device by way of a host computer via the controlling of the main-controlling chip.

The second objective of the present invention is to provide an integrated USB hub having at least five electrical connectors, wherein the five electrical connectors comprises at least one first electrical connector, at least one second electrical connector and a plurality of fourth connectors, therefore, comparing to the conventional USB hub, it is increased the usable electrical connectors for the user.

Accordingly, to achieve the abovementioned objectives of the present invention, the inventor proposes an integrated USB hub, comprising:

a circuit board;

a first electrical connector, disposed on the circuit board and used for connecting to a host computer;

a main-controlling chip, coupled to the first electrical connector;

at least one second electrical connector, coupled to the main-controlling chip and adopted for connecting to a first electronic device;

at least one third electrical connector, coupled to the main-controlling chip and adopted for connecting to a second electronic device; and

a plurality of fourth electrical connectors, coupled to the main-controlling chip and adopted for connecting to a third electronic device;

wherein when the first electronic device is connected to the second electrical connector, the host computer is able to control the first electronic device through the main-controlling chip and the second electrical connector;

wherein when the first electronic device is connected to the second electrical connector and the second electronic device is connected to the third electrical connector, the host computer can control the first electronic device through the main-controlling chip and the second electrical connector, and control the second electronic device via the main-controlling chip and the third electrical connector;

wherein when the first electronic device and the second electronic device are connected to the second electrical connector and the third electrical connector at the same time and the third electronic device is connected to the fourth electrical connector, the host computer is able to control the first electronic device through the main-controlling chip and the second electrical connector, control the second electronic device via the main-controlling chip and the third electrical connector, and control the third electronic device by way of the main-controlling chip and the fourth electrical connector.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a framework diagram of a conventional USB hub;

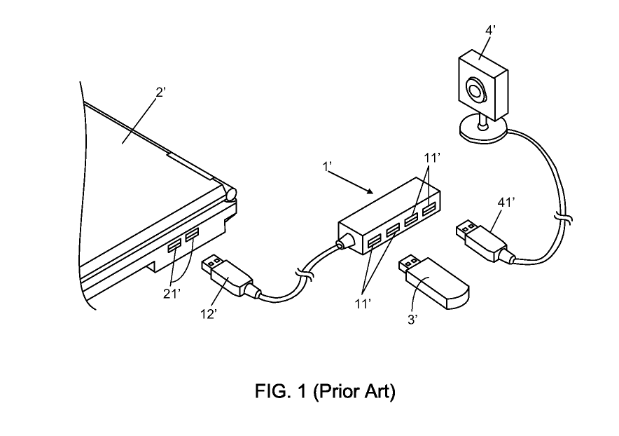

FIG. 2 is a stereo view of an improved conventional USB hub;

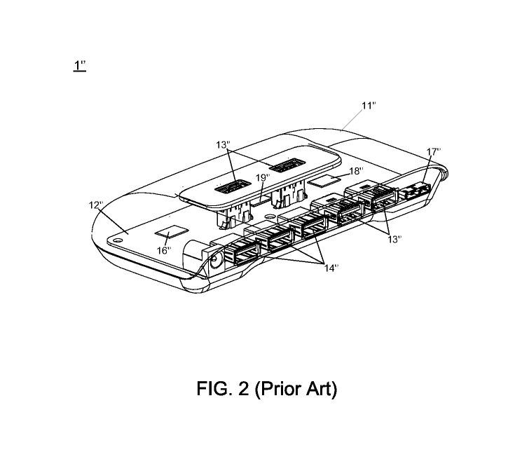

FIG. 3 is a circuit framework diagram of a circuit board of the improved conventional USB hub;

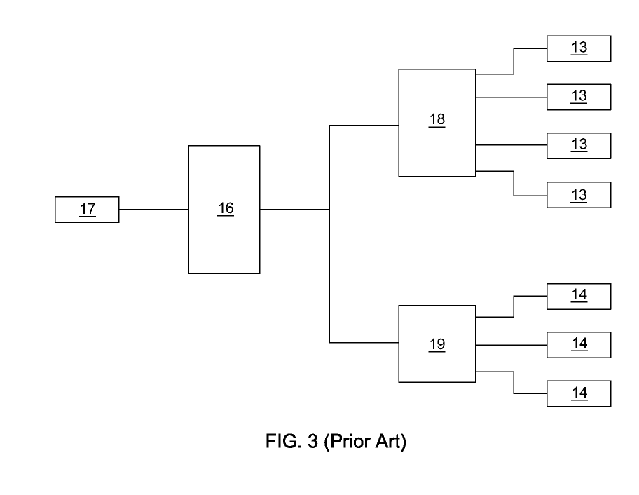

FIG. 4 is the framework diagram of an integrated USB hub according to the present invention;

FIG. 5 is a schematic stereo view of the integrated USB hub according to the present invention;

FIG. 6 is the framework diagram of a second embodiment of the integrated USB hub according to the present invention;

FIG. 7 is the framework diagram of a third embodiment of the integrated USB hub according to the present invention; and

FIG. 8 is the framework diagram of a fourth embodiment of the integrated USB hub according to the present invention.

### DETAILED DESCRIPTION OF THE INVENTION

To more clearly describe an integrated USB hub according to the present invention, embodiments of the present invention will be described in detail with reference to the attached drawings hereinafter.

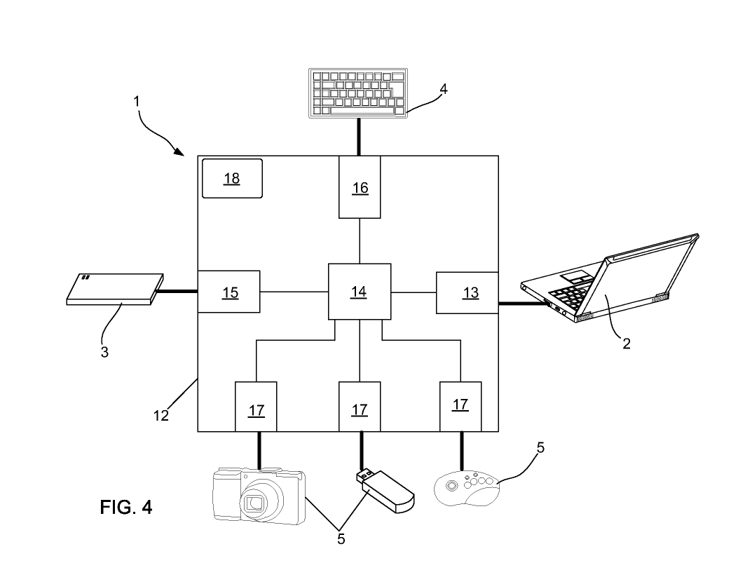

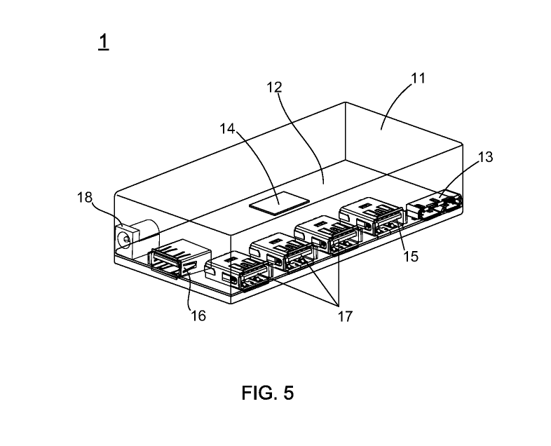

Please refer to FIG. 4 and FIG. 5, which illustrate a framework diagram and a schematic stereo view of the integrated USB hub according to the present invention. As shown in FIG. 4 and FIG. 5, the integrated USB hub 1 includes: a circuit board 12, a first electrical connector 13, a main-controlling chip 14, a second electrical connector 15, a third electrical connector 16, three fourth electrical connectors 17, and a power managing unit 18, wherein the circuit board 12 is accommodated by a housing 11; moreover, the first electrical connector 13, the main-controlling chip 14, the second electrical connector 15, the third electrical connector 16, the fourth electrical connectors 17, and the power managing unit 18 are disposed on the circuit board 12; in addition, the first electrical connector 13, the second electrical connector 15, the third electrical connector 16, the fourth electrical connectors 17, and the power managing unit 18 are exposed out of the housing 11 through a plurality of openings of the housing 11.

Referring to FIG. 4 and FIG. 5 again, the power managing unit 18 can be connected to an external power supplying device, so as to provide power to the first electrical connector 13, the main-controlling chip 14, the second electrical connector 15, the third electrical connector 16, and the fourth electrical connectors 17. The first electrical connector 13 can be mini-B type USB 3.0 electrical connector receptacle or a type-B USB 3.0 electrical connector receptacle, which is disposed on the circuit board 12 and used for connecting to a host computer 2. The second electrical connector 15 is an USB 3.0 electrical connector, which is coupled to the main-controlling chip 14 and adopted for connecting to a first electronic device 3; moreover, in the embodiment of the integrated USB hub 1, the highest data transfer rate of the second electrical connector 15 is 5 Gb/s. Thus, as shown in FIG. 4, when an external hard drive (the first electronic device 3) is connected to the second electrical connector 15, the host computer 2 is capable of accessing the external hard drive through the main-controlling chip 14 and the second electrical connector 15, and then the data stored in the external hard drive can be transmitted to the host computer 2 by a super high data transfer rate (5 Gb/s).

The third electrical connector 16 is an USB 2.0 electrical connector compatible with an external USB 1.0 electrical connector, which is coupled to the main-controlling chip 14 and adopted for connecting to a second electronic device 4; so that, in the embodiment of the integrated USB hub 1, the third electrical connector 16 can be connected to an USB 2.0 electrical connector or an USB 1.0 electrical connector disposed on the second electronic device 4; moreover, with the difference of the electrical connectors (the USB 2.0 electrical connector or the USB 1.0 electrical connector) disposed on the second electronic device 4, the third electrical connector 16 may transmit data by the data transfer rate of 480 Mb/s, 12 Mb/s, or 1.5 Mb/s. The fourth electrical connector 17 is an USB 3.0 electrical connector compatible with an external USB 2.0 electrical connector and an external USB 1.0 electrical connector, and is coupled to the main-controlling chip 14 for connecting a third electronic device 5, in addition, with the difference of the electrical connectors (the USB 3.0 electrical connector, the USB 2.0 electrical connector or the USB 1.0 electrical connector) disposed on the third electronic device 5, the fourth electrical connector 17 may transmit data by the data transfer rate of 5 Gb/s, 480 Mb/s, 12 Mb/s, or 1.5 Mb/s.

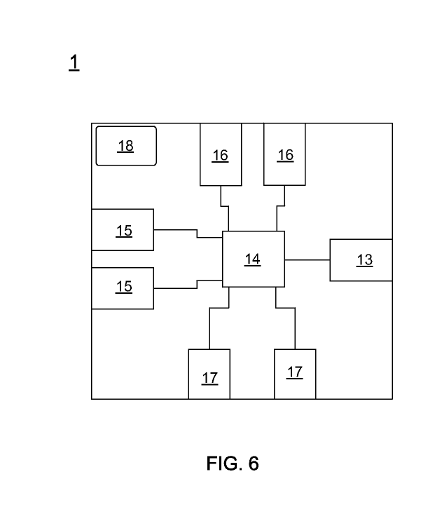

Besides, for the integrated USB hub of the present invention, the total number of the electrical connector ports can be further increased to 6 ports, 7 ports or 8 ports by way of reducing one of the fourth electrical connectors 17 and increasing a second electrical connector 15 and a third electrical connector 16. Please refer to FIG. 6, which illustrates the framework diagram of a second embodiment of the integrated USB hub according to the present invention. As shown in FIG. 6, comparing to the above embodiment, in the second embodiment of the integrated USB hub 1, the total number of the electrical connector ports are increased to 6 ports by way of reducing one of the fourth electrical connectors 17 and increasing a second electrical connector 15 and a third electrical connector 16. Therefore, as shown in FIG. 6, the integrated USB hub 1 includes two fourth electrical connectors 17, two second electrical connectors 15 and two third electrical connectors 16.

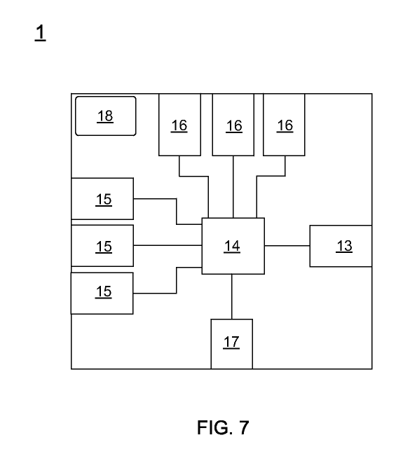

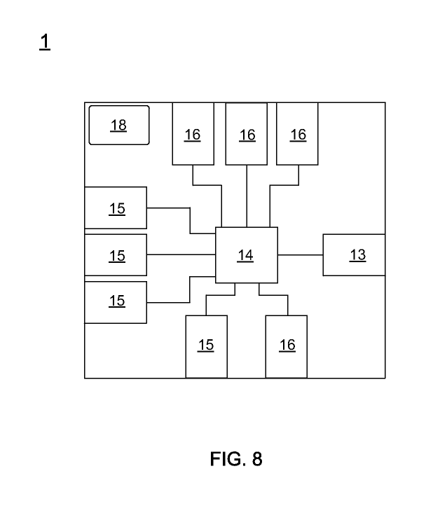

Furthermore, please refer to FIG. 7, which illustrates the framework diagram of a third embodiment of the integrated USB hub according to the present invention. As shown in FIG. 7, comparing to the second embodiment, in the third embodiment of the integrated USB hub 1, it reduces one of the fourth electrical connectors 17 again, and one second electrical connector 15 and one third electrical connector 16 are added into the framework of the integrated USB hub 1; therefore, the total number of the electrical connectors of the integrated USB hub 1 is increased to 7 ports. Eventually, please refer to FIG. 8, which illustrates the framework diagram of a fourth embodiment of the integrated USB hub according to the present invention. As shown in FIG. 8, comparing to the third embodiment, in the fourth embodiment of the integrated USB hub 1, the total number of the electrical connector ports is further increased to 8 ports by way of replacing all of the fourth electrical connectors 17 by four second electrical connectors 15 and four third electrical connectors 16.

Thus, through the above descriptions, the integrated USB hub of the present invention has been disclosed completely and clearly; Moreover, according to the above description and comparing to the conventional USB hub, it is able to understand that the integrated USB hub of the present invention has the characteristics and the advantages as follows:
1. In the present invention, the total number of the electrical connector ports of the integrated USB hub is increased to 5 ports by way of reducing one of the fourth electrical connectors 17 (i.e., reducing one of USB 3.0 electrical connector compatible with the external USB 2.0 electrical connector and the external USB 1.0 electrical connector.) and increasing a second electrical connector 15 (i.e., increasing one USB 3.0 electrical connector) and a third electrical connector 16 (i.e., increasing one USB 2.0 electrical connector compatible with the external USB 1.0 electrical connector.).
2. In the present invention, when the first electronic device 3 is connected to the second electrical connector 15 and the second electronic device 4 is connected to the third electrical connector 16, the host computer 2 can control the first electronic device 3 through the main-controlling chip 14 and the second electrical connector 15, and control the second electronic device 4 via the main-controlling chip 14 and the third electrical connector 16.
3. Inheriting to above point 2, moreover, when the first electronic device 3 and the second electronic device 4 are connected to the second electrical connector 15 and the third electrical connector 16 at the same time and the third electronic device 5 is connected to the fourth electrical connector 17, the host computer 2 is able to control the first electronic device 3 through the main-controlling chip 14 and the second electrical connector 15, control the second electronic device 4 via the main-controlling chip 14 and the third electrical connector 16, and control the third electronic device 5 by way of the main-controlling chip 14 and the fourth electrical connector 17.
4. Inheriting to above point 1, in the present invention, it can further increase the total number of the electrical connector ports of the integrated USB hub to 6 ports, 7 ports or 8 ports by way of continuously reducing one of the fourth electrical connectors 17 and increasing a second electrical connector 15 and a third electrical connector 16.

The above description is made on embodiments of the present invention. However, the embodiments are not intended to limit scope of the present invention, and all equivalent implementations or alterations within the spirit of the present invention still fall within the scope of the present invention.

I claim:

1. An integrated USB hub, comprising:
a circuit board;
a first electrical connector, being disposed on the circuit board and used for connecting to a host computer;
a main-controlling chip, being coupled to the first electrical connector;
at least one second electrical connector, being coupled to the main-controlling chip and adopted for connecting to a first electronic device;
at least one third electrical connector, being coupled to the main-controlling chip and adopted for connecting to a second electronic device; and
a plurality of fourth electrical connectors, being coupled to the main-controlling chip and adopted for connecting to a third electronic device;
wherein when the first electronic device is connected to the second electrical connector, the host computer being able to control the first electronic device through the main-controlling chip and the second electrical connector;
wherein when the first electronic device is connected to the second electrical connector and the second electronic device is connected to the third electrical connector, the host computer can control the first electronic device through the main-controlling chip and the second electrical connector, and control the second electronic device via the main-controlling chip and the third electrical connector;
wherein when the first electronic device and the second electronic device are connected to the second electrical connector and the third electrical connector at the same time and the third electronic device is connected to the fourth electrical connector, the host computer being able to control the first electronic device through the main-controlling chip and the second electrical connector, control the second electronic device via the main-controlling chip and the third electrical connector, and control the third electronic device by way of the main-controlling chip and the fourth electrical connector.

2. The integrated USB hub of claim 1, further comprising a housing for accommodating the circuit board, the first electrical connector, the main-controlling chip, the second electrical connector, the third electrical connector, and the fourth electrical connectors, and having a plurality of openings.

3. The integrated USB hub of claim 2, further comprising a power managing unit, being disposed on the circuit board used for providing power to the first electrical connector, the main-controlling chip, the second electrical connector, the third electrical connector, and the fourth electrical connectors.

4. The integrated USB hub of claim 1, wherein the first electrical connector can be an electrical connector receptacle selected from the group consisting of: a mini-B type USB 3.0 electrical connector receptacle and a type-B USB 3.0 electrical connector receptacle.

5. The integrated USB hub of claim 1, wherein the second electrical connector is an USB 3.0 electrical connector, capable of transmitting data by 5 Gb/s data transfer rate.

6. The integrated USB hub of claim 1, wherein the third electrical connector is an USB 2.0 electrical connector compatible with an external USB 1.0 electrical connector.

7. The integrated USB hub of claim 6, wherein the third electrical connector can transmit data by one data transfer rate selected from the group consisting: 480 Mb/s, 12 Mb/s, and 1.5 Mb/s.

8. The integrated USB hub of claim 1, wherein the fourth electrical connector is an USB 3.0 electrical connector compatible with an external USB 2.0 electrical connector and an external USB 1.0 electrical connector.

9. The integrated USB hub of claim 6, wherein the fourth electrical connector can transmit data by one data transfer rate selected from the group consisting: 5 Gb/s, 480 Mb/s and 12 Mb/s.

10. The integrated USB hub of claim 3, wherein the power managing unit can connect to an external power supplying device.

11. The integrated USB hub of claim 1, wherein the total number of electrical connector ports may be increased by way of reducing one of the fourth electrical connectors and increasing a second electrical connector and a third electrical connector.
